(19) United States
(12) Patent Application Publication
(10) Pub. No.: US 2015/0151719 A1
(43) Pub. Date: Jun. 4, 2015

(54) Wiper Blade, Wiper Arm and Connection Arrangement for a Windscreen Wiper System of a Vehicle

(71) Applicant: Daimler AG, Stuttgart (DE)

(72) Inventor: Eric Schumacher, Bingen (DE)

(21) Appl. No.: 14/407,828

(22) PCT Filed: Feb. 26, 2013
(86) PCT No.: PCT/EP2013/000552

§ 371 Date: Dec. 12, 2014

(30) Foreign Application Priority Data
Jun. 13, 2012 (DE) 10 2012 011 660.8

(51) Int. Cl. B60S 1/40; B60S 1/38

(52) U.S. Cl. CPC B60S 1/4048; B60S 1/3849; B60S 2001/4051

(57) ABSTRACT

A wiper blade for a windscreen wiper system of a vehicle includes a connection element with an upper part formed to fix the connection element to a wiper arm of the windscreen wiper system. A lower part supporting a base body of the wiper blade is mounted to rotate around an axis of rotation on the upper part. The connection element is able to be brought into a functional position that allows the wiping of the windscreen, in which at least one latch element arranged on the upper part is locked in place with a counterpart provided on the sides of the wiper arm. Due to the movement of the lower part relative to the upper part, the at least one latch element is able to be brought into an unlocked position, in which the connection element is able to be released by the wiper arm.

### BACKGROUND AND SUMMARY OF THE INVENTION

Exemplary embodiments of the invention relate to a wiper blade for a windscreen wiper system of a vehicle, which comprises a connection element. An upper part of the connection element serves for the fixing of the same to a wiper arm of the windscreen wiper system. A lower part is mounted to be rotated on a lower part, the lower part supporting a base body of the wiper blade. The connection element is able to be brought into a functional position that allows the wiping of the windscreen, in which at least one latch element arranged on the upper part is locked into place with a counterpart provided on the sides of the wiper arm. Furthermore, the invention relates to a wiper arm for a windscreen wiper system of a vehicle, on which such a wiper blade is able to be fixed, and a connection arrangement which comprises such a wiper blade and such a wiper arm.

German patent document DE 10 2008 011 449 A1 describes a connection of a wiper blade to a wiper arm by means of a wiper blade-side adapter, which is introduced into an end region of the wiper arm from below. Subsequently, the adapter is displaced, together with the wiper blade, towards an end of the wiper arm, so perpendicularly to the assembly direction, in order to achieve a locking of the adapter with respect to the wiper arm and thus the occupation of a functional position of the adapter. In this functional position, a latch element arranged on the adapter is brought into an opening formed in an end region of the wiper arm.

German patent document DE 102 12 441 A1 describes a wiper device having a flat wiper blade and a wiper arm, wherein an adapter, which supports spring rails and a wiper lip of the wiper blade, is introduced into an end region of the wiper arm from the front, so from the free end of the wiper arm. The end region of the wiper arm has a U-profile in cross-section. Latch protrusions provided on the adapter lock into the end region of the wiper arm, if the adapter has reached its functional position in which it is guided over the windscreen for the wiping of the windscreen by the wiper arm.

Here, the fact that the wiper blade is no longer securely supported on the wiper arm if the latch element is broken off is considered to be disadvantageous. Additionally, the handling of the wiper blade is comparably complex on disassembly because exchanging the wiper blade requires operation of latch elements.

Accordingly, exemplary embodiments of the present invention are directed to a wiper blade, a wiper arm, and a connection arrangement of the type referred to at the beginning, in which a particularly simple exchange of the wiper blade is enabled.

In the case of the wiper blade according to the invention, the at least one latch element is able to be brought into an unlocked position, in which the connection element is able to be released from the wiper arm, by moving the lower part relative to the upper part. Disassembly of the wiper blade therefore only requires twisting the lower part of the connection element relative to the upper part, which causes the latch connection between the at least one latch element and the counterpart provided on the sides of the wiper arm to be lifted. As the lower part supports the base body of the wiper blade, only the base body of the wiper blade is thus required to be rotated around the axis of rotation, relative to the upper part in order to achieve a release of the wiper blade from the wiper arm. Due to the fact that, for the release of the wiper blade from the wiper arm, no latch element is required to be operated, the disassembly of the wiper blade and thus the exchange thereof is particularly simple to accomplish. The removal of the used wiper blade therefore requires only a rotational movement without requiring latch geometry to be operated.

Since an operator exchanging the wiper blade grasps the base body of the wiper blade with his/her hand in order to be able to twist the base body with respect to the upper part, it is additionally prevented that the wiper blade is able to fall onto the vehicle after the release of the same from the wiper arm and is able to damage the vehicle.

In an advantageous embodiment of the invention, an end region of the connection element is able to be introduced into a receiver of the wiper arm to fix the connection element to the wiper arm by movement in an assembly direction running at an angle to a wiper surface that is able to be defined by a wiper movement of the wiper blade. By pivoting the connection element around a pivot axis provided in the end region, the at least one latch element is herein able to be locked into place with the counterpart. Due to the assembly of the connection element in the receiver from below, it is possible to keep the forces to be applied by the operator for the assembly and disassembly particularly low. Thus, assembly and disassembly are particularly customer-friendly and the exchange of the wiper blade is particularly simple.

Even if the at least one latch element should break, the connection element nevertheless remains in the receiver of the wiper arm. Thus, the wiper blade also remains in its functional position in the case of a breakage of the latch element, and it cannot be lost during the wiper operation. An ejection of the wiper blade is also prevented. The receiver, which is formed as a type of cage, can receive occurring forces particularly well during the wiper operation in the wiper direction, perpendicularly to the wiper direction and perpendicularly to a wiper surface that is able to be defined by the wiper movement of the wiper blade.

At least one abutment is preferably formed in the end region, the abutment being supported in the functional position of the connection element on a protrusion provided in the region of the receiver of the wiper arm. Due to such a fixed or rigid abutment, it can be particularly well ensured that the connection element remains in the functional position, even if the latch element is damaged or destroyed. Such a blocking geometry particularly securely prevents a self-release of the connection element, and with this of the wiper blade from the wiper arm during the wiper operation. The fixed abutment can, in particular, be provided by a step formed in the upper part.

Furthermore, the at least one latch element arranged on the upper part is advantageously formed as a snap-in pin, the free end of which is closer to a base body of the upper part in the unlocked position than for a snap-in pin that is locked into position with the counterpart.

Such a flexible snap-in pin can be particularly simply moved from a locked position, in which it is locked into place with the counterpart provided on the sides of the wiper arm, into the unlocked position, in which the wiper blade can be disassembled from the wiper arm without disruption.

The locking of the flexible snap-in pin onto the counterpart provided on the sides of the wiper arm is able to be felt and heard particularly well by the operator. Thus, achieving the end position, so the bringing of the connection element into the functional position, is communicated to the operator, such that the assembly of the wiper blade is achieved particularly intuitively.

It has been shown to be more advantageous if a hook element is arranged on the lower part, by means of which the at least one latch element arranged on the upper part is able to be moved into the unlocked position by the movement of the lower part. The hook element therefore interacts with the latch element such that the unlocking of the latch element and thus the disturbance-free release of the wiper blade from the wiper arm is able to be caused by components of the wiper blade which interact with one another.

The latch element is able to be brought particularly functionally securely into the unlocked position if, according to a further advantageous embodiment of the invention, the hook element passes through an opening provided in the snap-in pin. Then a particularly high level of stability is provided to the snap-in pin, and at the same time the hook element is particularly well guided, if the snap-in pin moves into the unlocked position by the twisting of the lower part relative to the upper part.

The wiper blade according to the invention is able to be fixed to the wiper arm according to the invention for a windscreen wiper system. A receiver of the wiper arm formed to receive the connection element herein has a U-profile in cross-section. The counterpart provided on the sides of the wiper arm is formed as a protrusion projecting inwardly from an arm of the receiver. Due to this cage-like geometry of the receiver, a particularly secure fixing of the connection element is able to be achieved in the functional position of the wiper blade.

It is furthermore advantageous if at least one further protrusion is provided on at least one arm of the receiver of the wiper arm, which is formed, in the case of the connection element brought into the functional position, for the support of an abutment provided on the connection element. Due to the provision of such corresponding geometries, the wiper blade is particularly well and securely fixed when the connection element is brought into the functional position. The abutment on the sides of the wiper blade can be formed particularly simply by a step which is supported on the further protrusion.

An end region of the receiver can be formed by a sealing element, which seals a receiving space of the receiver specified for the receiving of the connection element at least partially on the front side, and which is coupled to a base body of the wiper arm. As the sealing element is releasably arranged on the base body of the wiper arm, it can be particularly simply exchanged. Additionally, the front-side sealing of the receiving space ensures an optically attractive design of a connection arrangement comprising the wiper arm and the wiper blade.

It is furthermore advantageous if the sealing element protrudes, at least in certain regions, over a lower side of the receiver space. It can, in particular, arise that, after the disassembly of the wiper blade from the set-up wiper arm, so the wiper arm that is folded away from the windscreen, the operator pushes against the wiper arm out of carelessness and this then impacts against the windscreen. Due to the fact that the sealing element projects over the lower side of the receiver space, it serves, in such a case, as impact protection and thus protects the windscreen that is to be wiped from being damage.

The sealing element can, in particular, be formed from a plastic, such that, on striking the same on the windscreen, damage to the windscreen is particularly securely prevented. Additionally, the sealing element then has a lower specific weight than the base body of the wiper arm which is conventionally formed from a metal.

The connection arrangement according to the invention for a windscreen wiper system of a vehicle comprises a wiper arm according to the invention, on which a wiper blade according to the invention is fixed by means of a connection element of the wiper blade.

The advantages described for the wiper blade according to the invention and preferred embodiments also apply for the wiper arm according to the invention as well as for the connection arrangement according to the invention, and vice versa.

The features and feature combinations referred to above in the description as well as the features and feature combinations referred to below in the description of the figures and shown solely in the figures are not only able to be used in the respectively specified combination, but also in other combinations or alone, without leaving the scope of the invention.

### BRIEF DESCRIPTION OF THE DRAWING FIGURES

Further advantages, features and details of the invention result from the claims, the below description of preferred embodiments as well as by means of the drawings. Here are shown:

FIG. 1 in an exploded depiction and perspectively, a connection arrangement for a windscreen wiper system of a vehicle, wherein the connection arrangement comprises a wiper arm and a wiper blade of the windscreen wiper system;

FIG. 2 in sections, the wiper arm in a perspective view from below;

FIG. 3 a first perspective view of an upper part of an adapter, by means of which the wiper blade is fixed to the wiper arm;

FIG. 4 the upper part of a further perspective view;

FIG. 5 in sections, the wiper blade having the adapter formed for fixing the same to the wiper arm in a perspective view;

FIG. 6 a first step of the assembly of the wiper blade onto the wiper arm, wherein the adapter is introduced into a receiver formed in an end region of the wiper arm at an angle from below;

FIG. 7 the screwing of the adapter into the receiver, wherein a flexible abutment of the adapter formed as a snap-in pin is attached to bars provided on the wiper arm;

FIG. 8 the locking of the flexible abutment onto the bars and thus the bringing of the adapter into its functional position by further screwing in of the same;

FIG. 9 the twisting of a lower part of the adapter with respect to the upper part of the adapter supported in the receiver of the wiper arm for the disassembly of the wiper blade;

FIG. 10 a further twisting of the lower part, which leads to the snap-in pin provided on the upper part being moved into an unlocked position in which it is no longer locked in place with the bars; and

FIG. 11 the removal of the unlocked adapter from the receiver of the wiper arm for the disassembly of the wiper blade.

### DETAILED DESCRIPTION

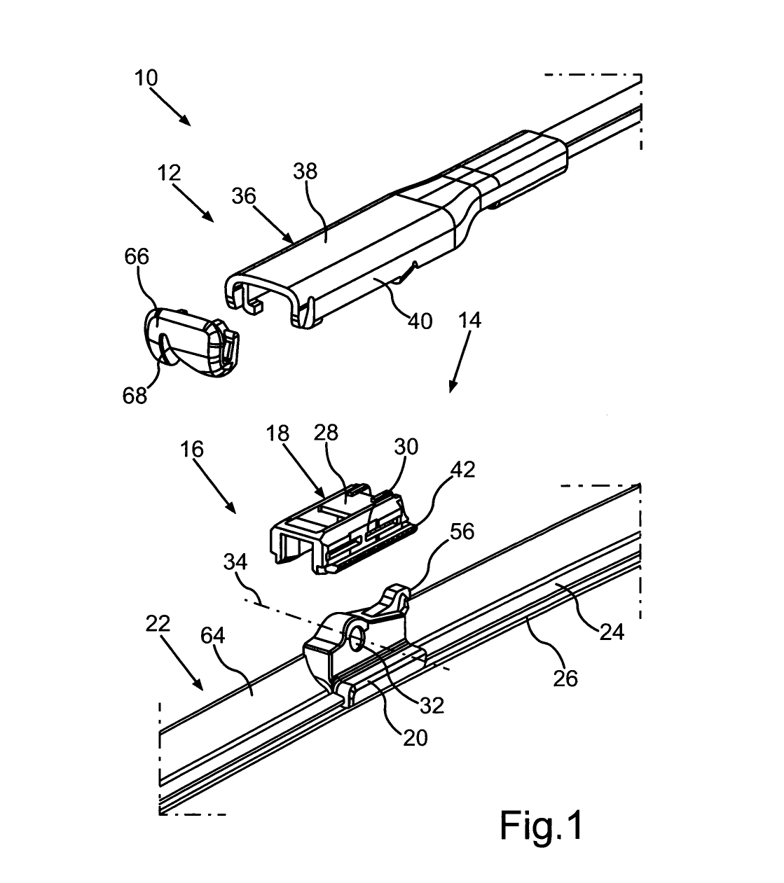

In FIG. 1, components of a wiper arm 12 and of a wiper blade 14 are shown perspectively of a connection arrangement 10 of a windscreen wiper system for a vehicle. A connection element in the form of an adapter 16 serves for the fixing of the wiper blade 14 onto the wiper arm 12.

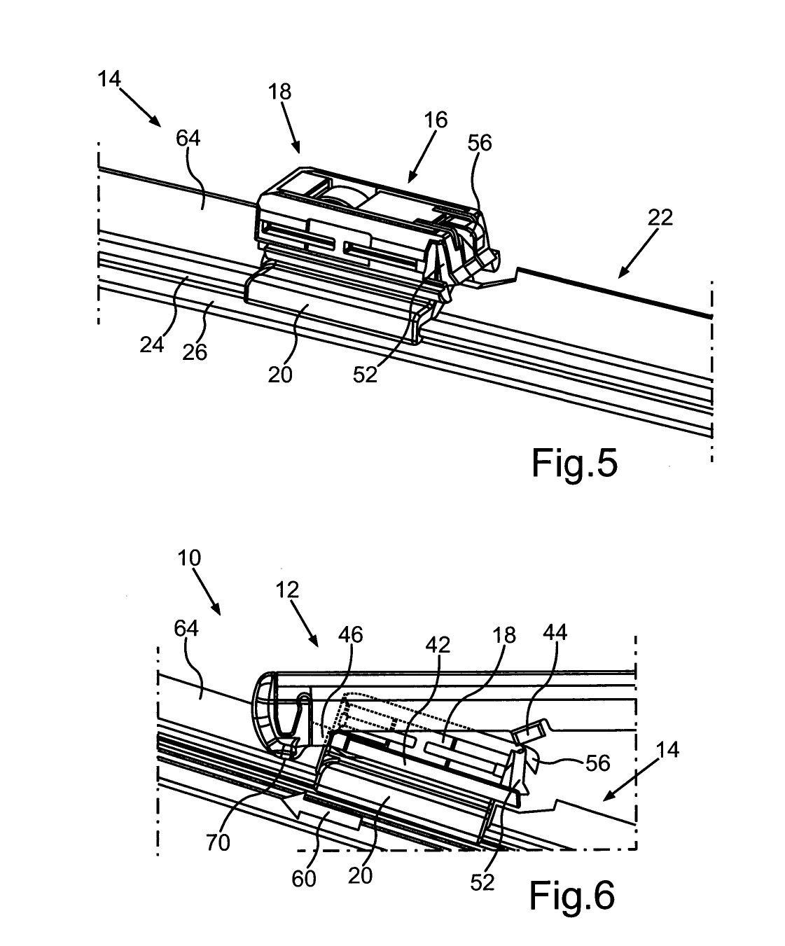

The adapter 16 comprises an upper part 18, which has a U-profile in cross-section, and a lower part in the form of a slider 20, which supports a base body 22 of the wiper blade 14. The base body 22 presently comprises spring rails 24 and a wiper lip 26 of the wiper blade 14. The upper part 18 of the adapter 16 comprises a back 28 and lateral arms 30 connected to the back 28. A metal pin (not shown) is supported on the lateral arms 30 of the upper part 18, which, in the case of the upper part 18 fixed onto the slider 20 (cf. FIG. 5), passes through an opening 32 which is formed in a bar-shaped region of the slider 20. An axis of rotation 34 is provided by the metal pin, which is mounted in the opening 32.

Thus, the slider 20 and with this the base body 22 of the wiper blade 14 is able to be pivoted relative to the upper part 18 around this axis of rotation 34. Thus the wiper blade 14 that is fixed to the wiper arm 12 by means of the adapter 16 can be moved relative to the wiper arm 12 and can thus follow the curve of the windscreen to be wiped in the wiper operation.

Here, provision can be made for the base body 22 of the wiper blade 14 to be able to be moved relative to the upper part 18 supported on the wiper arm 12 by +/−5 degrees with regard to the horizontal. The pendulum motion of the slider 20 in the upper part 18 is limited by the stops 42 which are provided on the arms 30 of the upper part 18.

The adapter 16 has, if the upper part 18 is connected to the slider 20, a substantially rectangular design (cf. FIG. 5). To receive this rectangular adapter 16, a receiver 36 is provided in a front end region of the wiper arm 12, wherein the wiper arm 12 likewise has a U-profile in cross-section in the region of the receiver 36. A back 38 and arms 40 of the receiver 36 encompass the adapter 16 received in the receiver 36 (cf. FIG. 8).

This ensures that no tipping occurs within the receiver 36 during the movement of the slider 20 relative to the upper part 18. Likewise, a detaching of the wiper blade 14 from the wiper arm 12 is prevented by the cage-like geometry of the receiver 36.

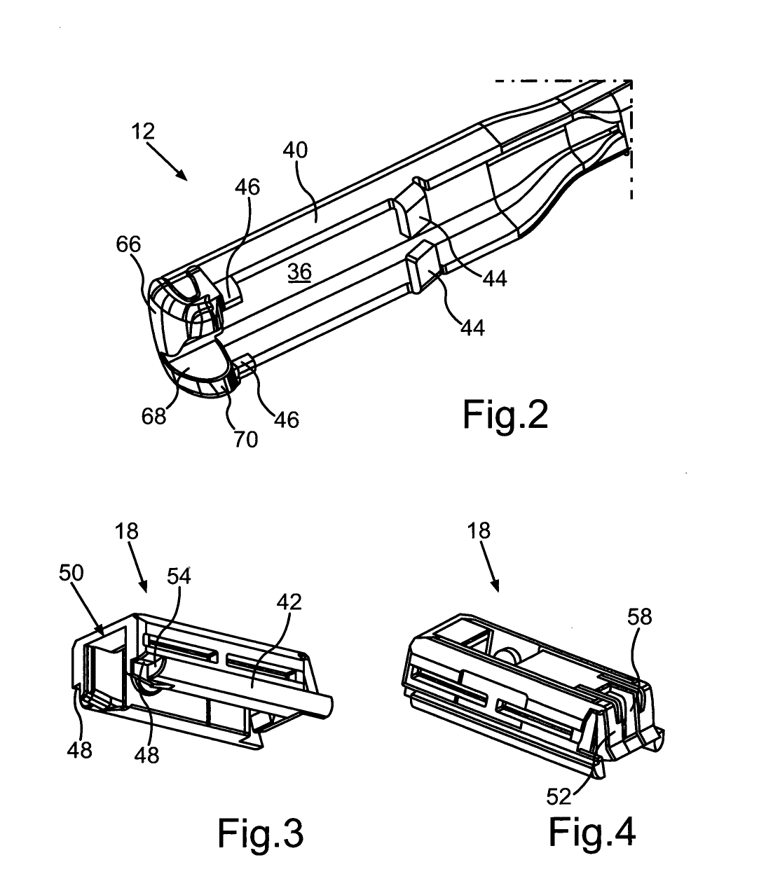

In particular, it is evident from FIG. 2 that protrusions in the form of bars 44, 46 project inwardly from the arms 40 of the receiver 36 of the wiper arm 12. The bars 46 that are closer to a free end of the wiper arm 12, so the front bars, serve for the rear engagement for a fixed abutment of the upper part 18, which is provided on the upper part 18 in the form of a step 48 (cf. FIG. 3). These steps 48 are formed in a front end region 50 of the upper part 18 and are supported on the front bars 46, if the adapter 16 is received in the receiver 36 of the wiper arm 12.

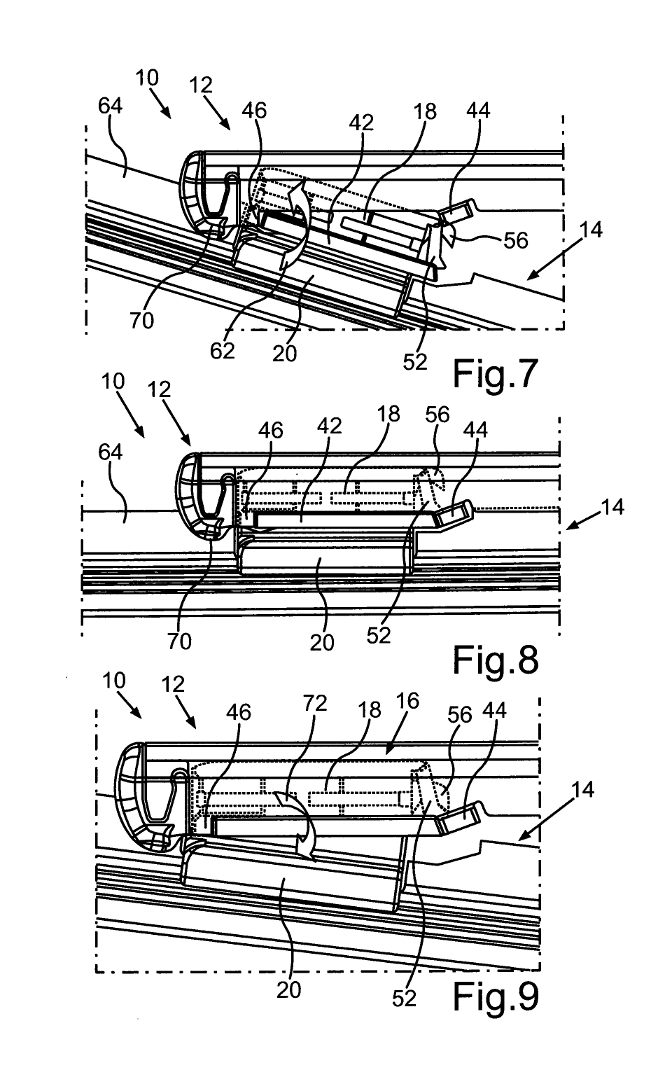

The two rear bars 44, which project inwardly from the arms 40 of the receiver 36 of the wiper arm 12, serve as counterparts for a latch element in the form of a snap-in pin 52 provided in a rear end region of the upper part 18 (cf. FIG. 4). The snap-in pin 52 is flexible, and it is bent on introduction of the adapter 16 into the receiver 36 from below (cf. FIG. 7) towards the front end region 50 of the upper part 18, before a free end of the snap-in pin 52 engages behind the bars 44 (cf. FIG. 8).

In particular, in an overview with FIG. 7, and as illustrated in FIG. 3 end stops are provided by front ends 54 of the stops 42, which prevent the adapter 16 from being able to move out of the receiver 36 in the longitudinal extension direction of the wiper arm 12. Furthermore, these end stops limit the introduction of the adapter 16 into the receiver 36 at angle from below.

FIG. 5 shows the wiper blade 14 having the adapter 16 fixing the wiper blade to the wiper arm 12, wherein the upper part 18 is supported on the slider 20 to be able to pivot in the manner of a rocker. In particular, as well illustrated in this view, an unlocking hook 56 arranged on the bar-shaped region of the slider 20 passes through an opening 58, which is formed in the snap-in pin 52. The function of this unlocking hook 56 interacting with the flexible snap-in pin 52 is described below.

As can be seen in FIG. 6, the adapter 16 is introduced into the receiver 36 at an angle from below to fix the wiper blade 14 to the wiper arm 12. In FIG. 6, a movement arrow 60 illustrates a corresponding assembly direction, which runs at an angle to a wiper surface that is able to be defined by the wiper movement of the wiper blade 14.

The front bars 46 of the wiper arm 12 herein form end stops for the lateral stops 42 which are provided on the upper part 18 of the adapter 16. If the ends 54 of these stops 42 (cf. FIG. 2) are connected to the bars 46, the steps 48 provided on the front side on the upper part 18 (cf. FIG. 3) are supported on the front bars 46.

The adapter 16 is now screwed into the receiver 36, so pivoted around a pivot axis, which is provided in its front end region 50. A corresponding rotational movement is illustrated in FIG. 7 by a further arrow 62. This rotational movement leads to the flexible snap-in pin 52 being inserted onto the rear bars 44, so connected to these bars 44. When the wiper blade 14 is screwed in further around the pivot axis provided in the front end region of the adapter 16, the snap-in pin 52 is bent towards the front end region 50 of the adapter 16.

After the application of excess pressure of the rear bars 44, the snap-in pin 52 engages behind the rear bars 44 (cf. FIG. 8), due to which the deposit areas for the free end of the snap-in pin 52 are provided. This locking of the snap-in pin 52 on the rear bars 44 as a consequence of screwing the adapter 16 into the receiver 36 is able to be heard and felt by the operator who is assembling the wiper blade 14 on the wiper arm 12. Thus, the operator receives feedback that the functional position of the adapter 16 is achieved in the receiver 36 (cf. FIG. 8).

The wiper blade 14 comprises a spoiler 64. So that this does not prevent the introduction of the adapter 16 into the receiver of the wiper arm 12 at an angle from below (cf. FIG. 6), a sealing cap 66 or deflector cap which can be inserted from below onto the free end of the wiper arm 12 has a slot 68 with which the spoiler 64 engages and which provides an anti-rotation lock for the wiper blade 14.

In particular, it is furthermore evident from FIG. 8 that the sealing cap 66 has a protrusion 70 projecting over a lower edge of the receiver 36. This protrusion 70 prevents the windscreen from being damaged if the wiper arm 12 is not equipped with the wiper blade 14 and it impacts against the windscreen.

The approach during the disassembly of the wiper blade 14 can be illustrated by means of FIG. 9. The slider 20 is twisted downwards with respect to the upper part 18. This occurs by twisting the base body 22 with respect to the upper part 18. A corresponding rotational movement is illustrated in FIG. 9 by a further movement arrow 72. Thus, the unlocking hook 56 is connected to the snap-in pin 52 that is supported on the lower bars 44 (cf. FIG. 9). Here, the base body 22 of the wiper blade 14 is furthermore twisted with respect to the upper part 18, as this is the case in normal wiper operation.

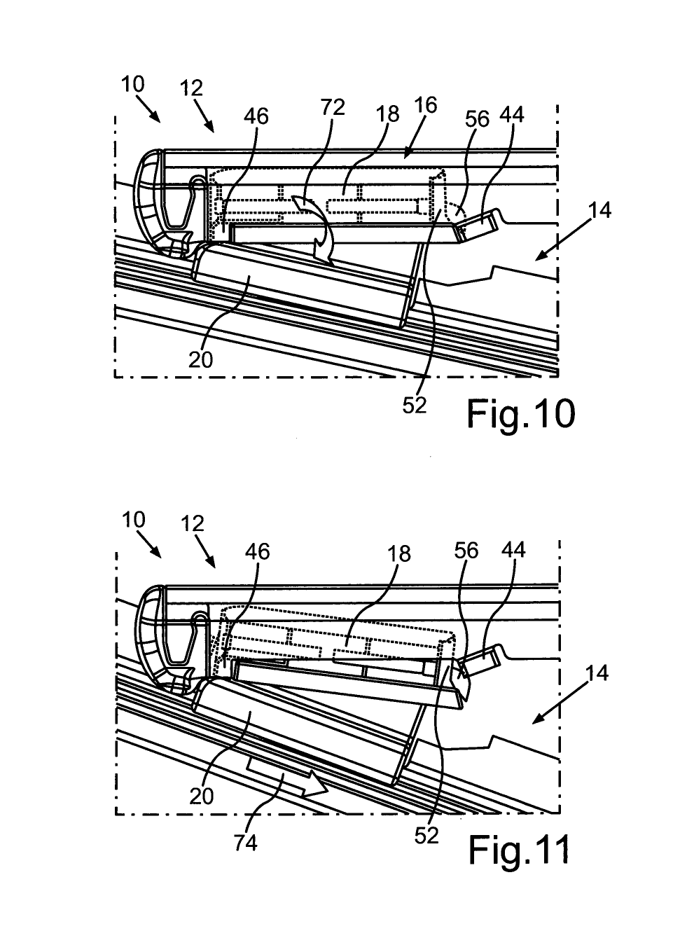

If the rotational movement is continued while the unlocking hook 56 is already in contact with the snap-in pin 52, then the unlocking hook 56 bends the snap-in pins 52 further. The unlocking hook 56 thus brings the snap-in pin 52 into an unlocked position in which the free end of the snap-in pin 52 no longer touches the lower bars 44 (cf. FIG. 10). The lower bars 44 therefore no longer prevent the screwing out of the upper part 18 from the receiver 36 and the adapter 16 is able to be released from the wiper arm 12 without disturbance.

The adapter 16, and with this the wiper blade 14, can then be removed downwards from the wiper arm 12 in a disassembly direction that is opposite to the assembly direction and which is illustrated in FIG. 11 by a further arrow 74.

During disassembly, the adapter 16 is therefore removed downwards from the recess 36 after an over-rotation of the base body 22 of the wiper blade 14 relative to the upper part 18. The unlocking hook 56 herein interacts on the slider 20 with the flexible abutment in the form of the snap-in pin 52 of the upper part 18. The snap-in pin 52 is thus bent into an unlocked position in which its free end no longer touches the lower bars 44. After that, the wiper blade 14 can be removed from the wiper arm 12 downwards.

During assembly, the adapter 16 is introduced accordingly into the receiver 36 at an angle from below (cf. FIG. 6), until the upper part 18 can no longer be moved further in the assembly direction. Subsequently, the adapter 16 is screwed into the receiver 36 until the insertion of the flexible abutment in the form of a snap-in pin 52. Due to the over pressure of the flexible abutment that is able to be detected and felt, the adapter 16 is then brought into its end position or functional position (cf. FIG. 8).

Due to the unlocking hook 56 and the snap-in pin 52 that is able to be operated by this, interactive locking is thus provided which enables a disassembly of the wiper blade 14 from the wiper arm 12 without a latch element herein being required to be operated by hand.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A wiper blade for a windscreen wiper system of a vehicle, comprising:
a connection element, which comprises
an upper part configured to fix the connection element to a wiper arm of the windscreen wiper system,
a lower part supporting a base body of the wiper blade,
wherein the lower part is rotatably mounted around an axis of rotation to the upper part,
wherein, in a functional position of the connection element allowing wiping of the windscreen the connection element, at least one latch element arranged on the upper part is locked in place with a counterpart element on sides of the wiper arm, and
wherein the upper and lower parts are configured so that movement of the lower part relative to the upper part causes the at least one latch element is move into an unlocked position in which the connection element is releasable from the wiper arm.

12. The wiper blade of claim 11, wherein the connection element includes an end region that is insertable into a receiver of the wiper arm to fix the connection element to the wiper arm by movement in an assembly direction running at an angle to a wiper surface defined by a wiper movement of the wiper blade, wherein the at least one latch element is locked into place with the counterpart element by pivoting the connection element around a pivot axis provided in the end region.

13. The wiper blade of claim 12, wherein the end region includes an abutment in the form of a step that is supported in the functional position of the support element on a protrusion in a region of the receiver of the wiper arm.

14. The wiper blade of claim 11, wherein the at least one latch element arranged on the upper part is a snap-in pin, the free end of which is closer in the unlocked position to a basic body of the upper part than for snap-in pins that locked into place with the counterpart element.

15. The wiper blade of claim 14, wherein the lower part includes a hook element is arranged on the lower part, by means of which the at least one latch element arranged on the upper part is moveable into the unlocked position by the movement of the lower part relative to the upper part.

16. The wiper blade of claim 15, wherein the hook element passes through an opening provided in the snap-in pin.

17. A wiper arm for a windscreen wiper system of a vehicle,
wherein the wiper arm is configured to be fixed to a wiper blade having a connection element, which comprises
an upper part configured to fix the connection element to the wiper arm,
a lower part supporting a base body of the wiper blade,
wherein the lower part is rotatably mounted around an axis of rotation to the upper part,
wherein, in a functional position of the connection element allowing wiping of the windscreen the connection element, at least one latch element arranged on the upper part is locked in place with a counterpart element on sides of the wiper arm,
wherein the upper and lower parts are configured so that movement of the lower part relative to the upper part causes the at least one latch element is move into an unlocked position in which the connection element is releasable from the wiper arm,
wherein the wiper arm includes a receiver configured to receive the connection element,
wherein the receiver has a U-profile in cross-section, and
wherein the counterpart element provided on the sides of the wiper arm is a protrusion projecting inwardly from an arm of the receiver.

18. The wiper arm of claim 17, wherein the at least one arm of the receiver of the wiper arm includes at least one further protrusion, which when the connection element is brought into the functional position, supports an abutment provided on the connection element.

19. The wiper arm of claim 17, wherein an end region of the receiver is formed by a sealing element that seals a receiver space of the receiver on a front side at least in regions, which is coupled to the base body of the wiper arm and which projects over a lower side of the receiver space at least in regions.

20. A connection arrangement for a windscreen wiper system of a vehicle, the connection arrangement comprising:
a wiper arm; and
a wiper blade having a connection element, which comprises
an upper part configured to fix the connection element to the wiper arm of the windscreen wiper system,
a lower part supporting a base body of the wiper blade,
wherein the lower part is rotatably mounted around an axis of rotation to the upper part,
wherein, in a functional position of the connection element allowing wiping of the windscreen the connection element, at least one latch element arranged on the upper part is locked in place with a counterpart element on sides of the wiper arm,
wherein the upper and lower parts are configured so that movement of the lower part relative to the upper part causes the at least one latch element is move into an unlocked position in which the connection element is releasable from the wiper arm,
wherein the wiper arm includes a receiver configured to receive the connection element,
wherein the receiver has a U-profile in cross-section, and
wherein the counterpart element provided on the sides of the wiper arm is a protrusion projecting inwardly from an arm of the receiver.
